(19) United States
(12) Patent Application Publication
(10) Pub. No.: US 2012/0014374 A1
(43) Pub. Date: Jan. 19, 2012

(54) Method, Device, and Computer Program Product for Adaptive Routing of Communications Across One or More Networks

(76) Inventors: Daniel J. Yaniro, JR., Freehold, NJ (US); Nabil Esphahani, New York, NY (US)

(21) Appl. No.: 12/835,203

(22) Filed: Jul. 13, 2010

(51) Int. Cl. H04L 12/28

(52) U.S. Cl. 370/352; 370/351

(57) ABSTRACT

Communications are adaptively routed across at least one network. Responsive to a dynamic user request for routing of communications at a particular service level, available routes within the network are determined for routing the communications. Route quality characteristics are determined for routes within the network for routing the communications. A route for routing the communications for the user is determined based on the available routes, the route quality characteristics, and the particular service level requested by the user.

### TECHNICAL FIELD

The present disclosure relates generally to telecommunications, and, more particularly, to adaptively routing communications.

### BACKGROUND

Currently, in order to support voice calls on data networks, such as Internet Protocol (IP) networks with different quality objectives, significant investment is needed by network operators to build separate networks that either provide voice quality equivalent to that of circuit-switched networks or that provide lesser voice quality. Traditional circuit-switched level of service is not required for every user and/or for ever call a particular user makes. Some users may choose to subscribe to voice service carried over IP networks with less expensive providers that do not offer quality similar to that of circuit-switched networks. These users may be willing to accept lower call completion rates, poorer voice quality, etc., for a lower cost. Current routing based on IP Class of Services (IPCoS) provides priority routing of calls across an IP network at the packet level but does not provide the capability or flexibility of service level routing.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to one embodiment, a method is provided for adaptive routing of communications at least one network. Responsive to a dynamic user request for routing of at least one communication at a particular service level, available routes within the network for routing the communication are determined. Route quality characteristics are determined for routes within the network for routing the communication. A route for routing the communication for the user is determined based on the available routes, the route quality characteristics, and the particular service level requested by the user.

According to another embodiment, a device for adaptive routing of communications across at least one network is provided. The device includes an input for receiving a dynamic user request for routing of at least one communication at a particular service level. The device further includes a processor for determining available routes within the network for routing the communication, determining route quality characteristics for routes within the network for routing the communication, and determining a route for routing the communication for the user based on the available routes, the route quality characteristics, and the particular service level requested by the user.

According to another embodiment, anon-transitory computer program product includes a storage medium upon which instructions are recorded that, when executed by a processor performs a method for adaptive routing of communications across at least one network. The method comprises, responsive to a dynamic user request for routing at least one communications at a particular service level, determining available routes within the network for routing the communication, determining route quality characteristics for routes within the network for routing the communication, and determining a route for routing the communication for the user based on the available routes, the route quality characteristics, and the particular service level requested by the user.

### BRIEF DESCRIPTION OF THE DRAWINGS

FIG. 1 illustrates an exemplary environment in which communications are adaptively routed according to an exemplary embodiment;

FIG. 2 illustrates in detail a device for adaptively routing communications according to an exemplary embodiment; and

FIG. 3 illustrates a method for adaptively routing communications according to an exemplary embodiment.

### DETAILED DESCRIPTION

Detailed exemplary embodiments are disclosed herein. It must be understood that the disclosed embodiments are merely exemplary examples that may be embodied in various and alternative forms, and combinations thereof. As used herein, the word “exemplary” is used expansively to refer to embodiments that serve as an illustration, specimen, model or pattern. The figures are not necessarily to scale, and some features may be exaggerated or minimized to show details of particular components. Therefore, specific structural and functional details disclosed herein are not to be interpreted as limiting.

In the following, the terms “communications”, “traffic” and “calls” are used interchangeably to refer to communications that may be routed according to various embodiments. Similarly, the terms “users” and “subscribers” are used interchangeably to refer to user of subscriber devices. Further, the terms “routes” and “paths” are used interchangeably to refer to routes across which communications flow.

According to exemplary embodiments, communications may be adaptively routed across one or more networks based on dynamic user requests indicating desired quality of service. In one embodiment, voice calls may be routed over data networks based on dynamic user requests specifying desired service levels. This technique may be implemented by, e.g., network providers and enterprise customers. Various embodiments allow for various qualities of service levels to be made available on a per-user basis (e.g., for a business, an individual user, a mobile user, etc.) and/or on a per-call basis for a given user without requiring that totally separate networks be utilized for each service level. This provides the ability for users to better control service levels for their communications, allows network operators to serve a variety of user needs with less infrastructure investment, and allows network operators additional revenue opportunity by charging users a premium for the ability to have service level routing as an enhancement to their existing service.

As an illustrative example, consider a business that supports stock trading. This business may desire an extremely high quality of service for communications, e.g., voice calls, during trading hours, lesser quality of service for calls after hours for their basic customers and high quality of service for calls all the time for their best customers. This business may also want to change service quality for calls as a function of stock market conditions. This may be done on an individual customer basis or on a location basis via a customer portal, as described in detail below.

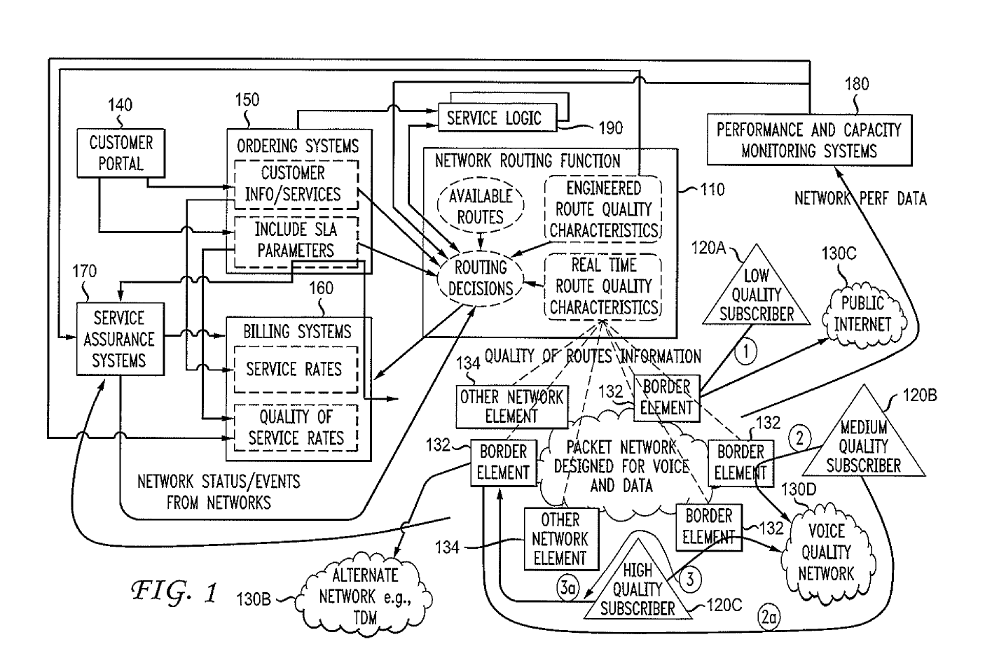

FIG. 1 illustrates an exemplary environment in which communications may be adaptively routed across networks according to exemplary embodiments. Referring to FIG. 1, a network routing device 110 receives dynamic user requests for routing a communication at a particular service level, e.g., a service level that was subscribed to by the user via a customer portal 140 and ordering system 150. The user may also dynamically request that the service level be changed via the customer portal and ordering system 150. Requests for routing communications may be initiated by subscribers, such as subscribers 120A, 120B, and 120C, via the customer portal 140. The customer portal may be implemented via, e.g., a website supported by a server. The ordering system 150, in turn, maintains customer and service information including a quality of service level profile (e.g., % of calls blocked, % of calls delayed, % of calls dropped, % of packet loss, based on time of day or location, etc.). This information may be translated either by an intermediate device or by the network routing device 110 into actionable routing parameters, e.g., types of paths that can be selected for a call, number of attempts/choices of paths to complete the call, etc.

The network routing device 110 maintains information regarding available routes and pre-engineered route quality characteristics. This information may be stored in a database in the network routing device 110, as described in more detail below. The static or pre-engineered route quality characteristics may include target utilization levels for different routes. For example, routes used for low quality service level traffic may be engineered to much higher utilization levels than routes reserved for high quality service level traffic. The pre-engineered route quality characteristics may also include information regarding types of routes. Types of routes may include, for example, less reliable network routes, such as the public interne 130C for lower quality traffic, very reliable network routes, such as the packet network 130A designed for handling voice and data for higher quality traffic, etc. Also, the pre-engineered route quality characteristics may include additional data, such as the number of attempts to complete calls for each route, etc.

The network routing device 110 also receives real-time route quality information from network elements, e.g., border elements 132, that provide communication services, such as call processing, conversion of signals into appropriate format for interfacing securely with other networks or customer locations, etc. The network routing device 110 also obtains information from service assurance systems 170 and performance and capacity management systems 180. The service assurance systems 170 monitor the performance of the various networks, e.g., the packet network 130A, the alternate network 130B, the public internet 130C, and the voice quality network 130D, detect network failure, and indicate network failure to the network routing device 110. The performance and capacity management systems 180 monitor the performance of the networks 130A, 130B, 130C, and 130D and provide data indicating the level of performance of the networks to the network routing device 110. Data provided by the performance and capacity management systems 180 may include, e.g., actual utilization levels, delay, jitter, packet loss, call completion rates, etc. for various routes. These systems may also apply controls to the networks to affect how calls are shed in case of congestion, e.g., data indicating that calls of users with lower subscribed quality of service are shed first. The network routing device 110 also maintains a database of available routes determined via provisioning and automated discovery. The network routing function 110 uses the information from the ordering system 150 indicative of the user's request for routing a communication at a particular service level and combines it with the pre-engineered route quality characteristics, real time route quality characteristics, and the available routes to determine a route for routing the communication.

According to exemplary embodiments, a user can access the customer portal 140 and make real-time changes to his or her subscribed quality of service. Based on user needs, users may subscribe to different quality levels based on time of day, day of week, calling or called location, etc. These real-time changes may be communicated to the billing system 160, such that billing may be adjusted as levels of service quality are changed, and to performance and capacity management systems 180 that would determine if the requested change can be supported by the network(s). For example, the change may be rejected or a later delivery date may be provided if these systems determine that the current design/performance of the network(s) cannot support the requested change.

The requested change in service may be communicated to the ordering system 150, which, in turn, validates with the network capacity and performance systems 180 that the newly requested plan can be supported before accepting and confirming the requested change. Requests that cannot be met may be forwarded to engineering and planning systems/organizations (not shown for simplicity of illustrations) so that potential upgrades to the network(s) can be planned.

The service assurance systems 170 may be linked to network engineered levels of performance and subscriber levels of service so that the network and customer assurance personnel can adapt their troubleshooting procedures to provide the required level of support. The performance and capacity management systems 180, in addition to providing the network routing device 110 device with real-time data it can use to route calls, provide the billing system 160 with call statistics that can be used to provide a rebate in a case in which a user's subscribed quality of service plan is not met. A rebate mechanism may be provided for calls that cannot be carried at the level that user desires. In such a case, the call may be routed, and the performance and capacity management systems 180 would detect that the quality is not high enough, SLAs are not being met, and events to cause a change to the user bill may be triggered. For example if call completion rates or measure of voice quality fall below a minimum threshold, the performance and capacity management systems 180 would notify the billing systems of this event for appropriate changes in billing treatment.

The service logic 190 includes application servers that perform various service functions and may also utilize the subscribed quality of service measures to perform call handling. The service logic 190 communicates with the ordering system 150 and with the network routing device 110 for this purpose.

To illustrate how adaptive communication routing works, consider the following examples. In one example, consider a communication request from a low quality subscriber 120A. This communication may be routed across the least costly path, and only one attempt made be made to complete the connection using that path. This is represented in FIG. 1 by path 1 from the low quality subscriber 120A to the public internet 130C via the border element 132.

As another example, consider traffic of subscribers to medium quality service. This traffic may use a more realizable path, such as a path from the medium quality subscriber 120B to the voice quality network 130D that has been engineered to carry voice. This is represented in FIG. 1 as path 2. Also, an attempt may be made to use a second path (represented in FIG. 1 as path 2a) for routing a communication. In this scenario, the second path may be one that had been reserved as an alternative (or primary) path for a high quality subscriber, e.g., a path through border element 132 and the packet network 130A. Using the real time network performance characteristics, the network routing device 110 may determine that the second path, at a particular instance, can be used for the call of a medium quality server subscriber, e.g., when the second path is so under-utilized that the communication will have an extremely low risk of impacting high-quality subscriber communications.

As yet another example, consider the traffic of a subscriber to high quality service. This traffic may be restricted to routes that would ensure performance meeting or exceeding a given target. For example, communications from high quality subscribers may be restricted from being routed over the public internet 130C or paths that have been engineered to the very high levels of utilization suitable for lower quality of service. This traffic may instead be routed on the best engineered paths, e.g., paths engineered to allow more attempts to be made to communicate. Such a path is represented in FIG. 1 as path 3 between the high quality subscriber 120C and the voice quality network 130D. Alternative available high quality paths may be made available to the high quality subscriber for communicating, as represented by path 3a between the high quality subscriber 120C and the packet network 130A via the border element 132 132. High quality subscriber service traffic may also be given higher priority than the communications from low quality service or medium quality service subscribers. Therefore, for example, if at some point the performance and capacity management systems 180 detect that a path carrying high quality of service traffic is becoming congested, and that path is also is carrying lower quality service level traffic, the lower quality of service calls using this path may be terminated by the network to attempt to maintain the high level of service for the calls for high quality service subscribers.

Although only three subscribers and four networks are shown in FIG. 1 for simplicity of illustration, it should be appreciated that any number and any suitable type of network may be used to route communications from any number of subscribers with any number of different quality of service level subscriptions according to exemplary embodiments. Further, it should be appreciated that various illustrated devices and systems not described in detail, e.g., performance monitoring system 180, service assurance systems 170, ordering system 150, billing system 160, and service logic 190 may be implemented in devices including a processor and a memory, similar to that described below.

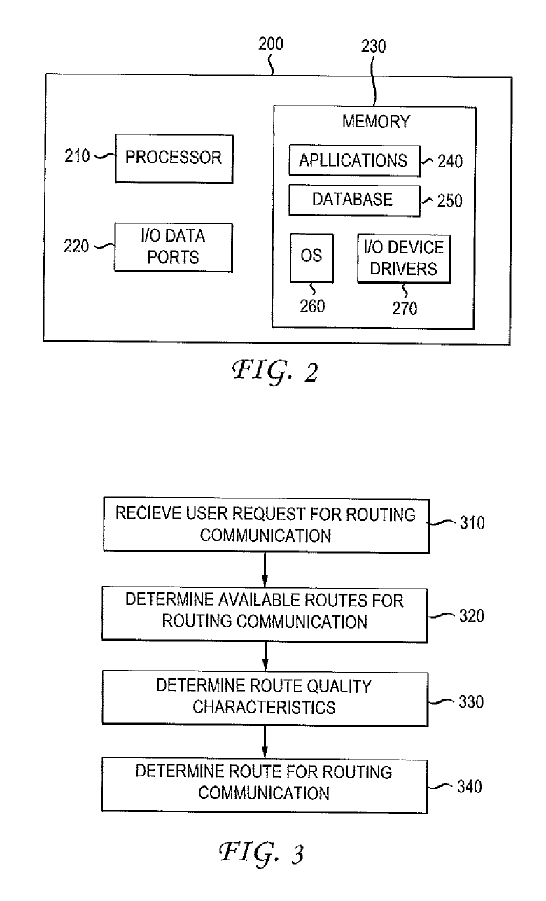

FIG. 2 illustrates in detail a device for adaptively routing communications according to an exemplary embodiment. The device 200 includes a processor 210 that receives user request information from ordering systems 150 and quality of route information from various network elements 132 and 134, performance and capacity management systems 180, service assurance systems 170, and service logic 190 via I/O data ports 220. The I/O data ports 220 can be implemented with, e.g., an interface including an antenna or other suitable type of transceiver through which data and signals may be transmitted and received.

The processor 210 communicates with the memory 230 via, e.g., an address/data bus. The processor 210 can be any commercially available or customer microprocessor. The memory is 230 is representative of the overall hierarchy of memory devices containing the software and data used to implement the functionality of the device 200. The memory 230 can include but is not limited to the following types of devices: processor registers, processor cache, RAM, ROM, PROM, EPROM, EEPROM, flash memory, SRAMD, DRAM other volatile memory forms, and non-volatile, semi-permanent or permanent memory types; for example, tape-based media, optical media, solid state media, hard disks, combinations thereof, and the like.

As shown in FIG. 2, the memory 230 may include several categories of software and data used in the device 200, including, applications 240, a database 250, an operating system (OS) 260, and the input/output (I/O) device drivers 270. As will be appreciated by those skilled in the art, the OS 260 may be any operating system for use with a data processing system. The I/O device drivers 270 may include various routines accessed through the OS 260 by the applications 240 to communicate with devices, and certain memory components. The applications 240 can be stored in the memory 230 and/or in a firmware (not shown) as executable instructions, and can be executed by the processor 210. The applications 240 include various programs that implement the various features of the device 200, including routing decision rules to apply to data stored in the database 250, such as available route data and pre-engineered route quality characteristics, and to data received via the I/O data ports 220, e.g., real-time route quality characteristics, to determine routes for routing communications by the processor 210. The database 250 represents the static and dynamic data used by the applications 240, the OS 260, the I/O device drivers 270 and other software programs that may reside in the memory. The database 250 may include, for example, stored information regarding available routes and pre-engineered route quality characteristics. The database 250 may also temporarily store or buffer received real-time quality of route characteristics.

While the memory 230 is illustrated as residing proximate the processor 210, it should be understood that at least a portion of the memory 230 can be a remotely accessed storage system, for example, a server on a communication network, a remote hard disk drive, a removable storage medium, combinations thereof, and the like. Thus, any of the data, applications, and/or software described above can be stored within the memory 230 and/or accessed via network connections to other data processing systems (not shown) that may include a local area network (LAN), a metropolitan area network (MAN), or a wide area network (WAN), for example.

It should be understood that FIG. 2 and the description above are intended to provide a brief, general description of a suitable environment in which the various aspects of some embodiments of the present disclosure can be implemented. While the description refers to computer-readable instructions, the present disclosure also can be implemented in combination with other program modules and/or as a combination of hardware and software in addition to, or in stead of, computer readable instructions. The term “application,” or variants thereof, is used expansively herein to include routines, program modules, programs, components, data structures, algorithms, and the like. Applications can be implemented on various system configurations, including single-processor or multiprocessor systems, minicomputers, mainframe computers, personal computers, hand-held computing devices, microprocessor-based, programmable consumer electronics, combinations thereof, and the like.

FIG. 3 illustrates a method for adaptive routing according to an exemplary embodiment. A dynamic user request for routing a communication at a particular service level is received at the network routing device 110 from the ordering system at step 310. At step 320, the network routing device 110 determines available routes within one or more networks for routing the communication based, e.g., on pre-determined, provisioned routes and or by automated discovery. At step 330, the network routing device 110 determines route quality characteristics for routes within the one or more networks for routing the communication based, e.g., on pre-engineered route quality information and real-time route quality information. At step 340, the network routing device 110 determines a route for routing the communication for the user based on the determined available routes, the determined route quality characteristics, and the particular service level requested by the user.

The law does not require and it is economically prohibitive to illustrate and teach every possible embodiment of the present claims. Hence, the above-described embodiments are merely exemplary illustrations. Variations, modifications, and combinations may be made to the above-described embodiments without departing from the scope of the claims. All such variations, modifications, and combinations are included herein by the scope of this disclosure and the following claims.

What is claimed is:

1. A method for adaptive routing of a communication across at least one network, comprising:
responsive to a dynamic user request for routing the communication at a particular service level:
determining available routes within the network for routing the communication;
determining route quality characteristics for routes within the network for routing the communication; and
determining a route for routing the communication for the user based on the available routes, the route quality characteristics, and the particular service level requested by the user.

2. The method of claim 1, further comprising changing the route for routing the communication for the user responsive to a change in service level requested by the user.

3. The method of claim 1, further comprising adjusting billing for routing the communication for the user based on the dynamic user request for routing the communication at the particular service level.

4. The method of claim 1, wherein determining the route occurs in near real time responsive to the dynamic user request and takes into account network status and events.

5. The method of claim 1, wherein the route quality characteristics include engineered characteristics of network elements and measured performance characteristics of the network elements.

6. The method of claim 1, wherein the network includes at least one of a network reserved for high service level communications routing and a network serving low service level communications routing.

7. The method of claim 1, wherein the communication is a voice call, and the network is a data network.

8. A device for adaptive routing of at least one communication across at least one network, comprising:
an input for receiving a dynamic user request for routing the communication at a particular service level; and
a processor for determining available routes within the network for routing the communication, determining route quality characteristics for routes within the network for routing the communication, and determining a route for routing the communication for the user based on the available routes, the route quality characteristics, and the particular service level requested by the user.

9. The device of claim 8, wherein the processor changes the route for routing the communication for the user responsive to a change in service level requested by the user.

10. The device of claim 8, wherein the processor adjusts billing for routing the communication for the user based on the dynamic user request for routing the communication at the particular service level.

11. The device of claim 8, wherein determining the route occurs in near real time responsive to the dynamic user request and takes into account network status and events.

12. The device of claim 8, wherein the route quality characteristics include engineered characteristics of network elements and measured performance characteristics of the network elements.

13. The device of claim 8, wherein the network includes at least one of a network reserved for high service level communications routing and a network serving low service level communications routing.

14. The device of claim 8, wherein the communication is a voice call, and the network is a data network.

15. A non-transitory computer program product including a storage medium upon which instructions are recorded that, when executed by a processor perform a method for adaptive routing of at least one communication across at least one network, comprising:
responsive to a dynamic user request for routing the communications at a particular service level:
determining available routes within the network for routing the communication;
determining route quality characteristics for routes within the network for routing the communication; and
determining a route for routing the communication for the user based on the available routes, the route quality characteristics, and the particular service level requested by the user.

16. The non-transitory computer program product of claim 15, wherein the processor further performs:
changing the route for routing the communication for the user responsive to a change in service level requested by the user.

17. The non-transitory computer program product of claim 15, wherein the processor further performs:
adjusting billing for routing the communication for the user based on the dynamic user request for routing the communication at the particular service level.

18. The non-transitory computer program product of claim 15, wherein determining the route occurs in near real time responsive to the dynamic user request and takes into account network status and events.

19. The non-transitory computer program product of claim 15, wherein the route quality characteristics include engineered characteristics of network elements and measured performance characteristics of the network elements.

20. The non-transitory computer program product of claim 15, wherein the communication is a voice call, and the network is a data network.
